(19) United States
(12) Patent Application Publication
(10) Pub. No.: US 2026/0365215 A1
(43) Pub. Date: Nov. 19, 2026

(54) LOAD TRANSPORT APPARATUS

(71) Applicant: MOTION DEVICE INC., Osan-si (KR)

(72) Inventor: Jong Chan LEE, Anyang-si (KR)

(21) Appl. No.: 19/497,293

(22) PCT Filed: Jun. 29, 2023
(86) PCT No.: PCT/KR2023/009135

§ 371 Date: Dec. 26, 2025

(30) Foreign Application Priority Data
Jun. 1, 2023 (KR) 10-2023-0070599

(51) Int. Cl. B62B 5/00

(52) U.S. Cl. CPC B62B 5/0083; B62B 5/0036; B62B 2301/14

(57) ABSTRACT

A load transport apparatus according to an embodiment includes: a loading plate on which an object to be loaded is mounted; a support frame for supporting the loading plate; a first lever member connected to a lower portion of a rear end portion of the support frame, coupled to the support frame to be relatively rotatable with respect to the support frame about a first rotation axis arranged in a first axis direction, and having a predetermined length in a second axis direction perpendicular to the first axis direction; a first driving wheel and a first driven wheel supported by both ends of the first lever member in the second axis direction and driven by a first driving motor; a second lever member connected to a lower portion of a front end portion of the support frame, coupled to the support frame to be relatively rotatable with respect to the support frame about a second axis arranged in the first axis direction, and having a predetermined length in the second rotation axis direction; a second driving wheel and a second driven wheel supported by both ends of the second lever member in the second axis direction and driven by a second driving motor; a third driven wheel connected to a lower portion of one side of a middle portion of the support member in the first axis direction; and a fourth driven wheel connected to a lower portion of the other side of the middle portion of the support frame in the first axis direction.

### TECHNICAL FIELD

The present invention relates to a load transport apparatus, and more particularly, to a load transport apparatus capable of stably transporting and unloading a load to another place.

### BACKGROUND ART

In recent years, with rapid development of a logistics industry, various types of logistics systems have been developed. For example, productivity is increased by increasing efficiency of logistics management using a logistics transport robot.

This logistics transport robot travels in a straight line by a driving motor in a state in which a load is loaded and transports the load to a set position.

The logistics transport robot according to the related art is disclosed in Korean Patent No. 10-1772631. Further, Korean Patent No. 10-1642728 is disclosed as a logistics transport system using a robot.

A driving wheel is driven to travel the logistics transport robot in a state in which a loading plate is provided on an upper side of the robot of the logistics transport system and a product to be transported is loaded on the loading plate. A plurality of driving wheels and a plurality of driven wheels are provided under front, rear, left, right sides of the robot.

In this way, when the driving wheels are rotationally driven to travel the logistics transport robot, when a floor is uneven, some of the driving wheels and the driven wheels in contact with the ground cannot be maintained and are spaced apart from the ground, and thus traveling stability is degraded during the traveling.

Meanwhile, a rocker-bogie structure is known as a link structure for traveling in a place in which the ground is uneven. The rocker-bogie structure is suitable for traveling in a place in which a height change is large, such as an uneven road or a stair, and thus is applied to various fields.

This rocker-bogie structure is difficult to apply to the logistics transport robot that transports a load having a high weight or has a narrow space for installing a driving part.

Korean Laid-Open Patent Publication No 10-2022-0079064 is disclosed as the related art of a robot to which the rocker-bogie structure is applied.

Thus, there is a need to develop a link structure suitable for the logistics transport robot in which the wheels in contact with the ground are maintained, the weight of the load is large, and the space for installing the driving part is narrow.

Meanwhile, when a load loaded on a load transport apparatus moves to a loading or unloading place, only when a height of a bottom surface of the load loaded on the load transport apparatus and a height (pass line) of the loading or unloading place match each other, the load may be loaded or unloaded. However, when the rocker-bogie structure is applied to the load transport apparatus, when a height of the loading plate is not maintained at a constant height and the loading plate is tilted to one side due to the weight of the loaded or unloaded load, the pass line is not matched, and thus an operation of loading or unloading the load cannot be performed smoothly.

### DETAILED DESCRIPTION OF INVENTION

### Technical Problem

The present invention is devised to solve the above problems and is directed to providing a load transport apparatus having improved traveling stability by allowing all wheels of the transport apparatus for transporting a load to always be in contact with the ground during traveling even when the ground is uneven.

### Technical Solution

The present invention according to an embodiment is directed to providing a load transport apparatus comprising: a loading plate on which an object to be loaded is seated; a support frame which supports the loading plate; a first lever member connected to a lower portion of a rear end portion of the support frame, coupled to the support frame to be relatively rotatable about a first rotary shaft disposed in a first axis direction with respect to the support frame, and having a predetermined length in a second axis direction perpendicular to the first axis direction; a first driving wheel and a first driven wheel supported on both ends of the first lever member in the second axis direction and driven by a first driving motor; a second lever member connected to a lower portion of a front end portion of the support frame, coupled to the support frame to be relatively rotatable about a second rotary shaft disposed in the first axis direction with respect to the support frame, and having a predetermined length in the second axis direction; a second driving wheel and a second driven wheel supported on both ends of the second lever member in the second axis direction and driven by a second driving motor; a third driven wheel connected to a lower portion of one side of a middle portion of the support frame in the first axis direction; and a fourth driven wheel connected to a lower portion of the other side of the middle portion of the support frame in the first axis direction.

The present invention according to another embodiment is directed to providing a load transport apparatus comprising: a loading plate on which an object to be loaded is seated; a support frame which supports the loading plate; a first lever member connected to a lower portion of a rear end portion of the support frame, coupled to the support frame to be relatively rotatable about a first rotary shaft disposed in a first axis direction with respect to the support frame, and having a predetermined length in a second axis direction perpendicular to the first axis direction; a pair of driving wheels supported on both ends of the first lever member in the second axis direction; a pair of driving motors for driving the pair of driving wheels supported on both ends of the first lever member in the second axis direction; a second lever member connected to a lower portion of a front end portion of the support frame, coupled to the support frame to be relatively rotatable about a second rotary shaft disposed in the first axis direction with respect to the support frame, and having a predetermined length in the second axis direction; a pair of driving wheels supported on both ends of the second lever member in the second axis direction; a pair of driving motors for driving the pair of driving wheels supported on both ends of the second lever member in the second axis direction; and a pair of driven wheels connected to both lower portions of a middle portion of the support frame in the first axis direction.

The first driving wheel and the second driving wheel are provided at two corner points of the support frame in a diagonal direction, the first driven wheel and the second driven wheel are provided at two corner points of the support frame in another diagonal direction, and the third driven wheel and the fourth driven wheel are each provided at a middle portion of a corresponding long side of the support frame.

The support frame includes a first support frame and a second support frame which share a pivot shaft disposed in the second axis direction, are provided on both sides of the pivot shaft, and are rotatable about the pivot shaft in an up-down direction.

The first driving wheel and the first driven wheel are provided under the first support frame at a position spaced apart rearward from the pivot shaft, the second driving wheel and the second driven wheel are provided at a lower portion of the second support frame at a position spaced apart forward from the pivot shaft, and the third driven wheel and the fourth driven wheel are provided directly under both ends of the pivot shaft in the second axis direction.

A loading plate rotation support part which supports the loading plate such that the loading plate is rotatable relative to the support frame is provided between a bottom surface of the loading plate and an upper surface of the support frame, and the loading plate rotation support part includes a pair of first loading plate rotation support parts positioned between a bottom surface of a rear portion of the loading plate and an upper surface of the first support frame and provided on both sides in the second axis direction, and a pair of second loading plate rotation support parts positioned between a bottom surface of a front portion of the loading plate and an upper surface of the second support frame and provided on both sides in the second axis direction.

The first loading plate rotation support part and the second loading plate rotation support part include a ball joint that allows relative rotation between the loading plate and the first support frame and the second support frame, and one of the first loading plate rotation support part and the second loading plate rotation support part is provided to reciprocally slide in the first axis direction perpendicular to the pivot shaft in conjunction with the rotation of the first support frame and the second support frame that relatively rotate about the pivot shaft.

The first loading plate rotation support part is provided at a position eccentric toward an axial line of a rotary shaft of the first driving wheel based on a middle between an axial line of the pivot shaft and the axial line of the rotary shaft of the first driving wheel in the first axis direction, and the second loading plate rotation support part is provided at a position eccentric toward an axial line of a rotary shaft of the second driving wheel based on a middle between the axial line of the pivot shaft and the axial line of the rotary shaft of the second driving wheel in the first axis direction.

The first rotary shaft is provided at a position eccentric toward the first driving wheel based on a middle in the second axis direction between an axial line in the first axis direction passing through a middle of the first driving wheel in the second axis direction and an axial line in the first axis direction passing through a middle of the first driven wheel in the second axis direction.

The second rotary shaft is provided at a position eccentric toward the second driving wheel based on a middle in the second axis direction between an axial line in the first axis direction passing through a middle of the second driving wheel in the second axis direction and an axial line in the first axis direction passing through a middle of the second driven wheel in the second axis direction.

An axial line in the first axis direction passing through a middle of the third driven wheel in the second axis direction is provided to be positioned eccentrically outward in the second axis direction compared to an axial line in the first axis direction passing through a center of the first driven wheel and a center of the second driving wheel, and an axial line in the first axis direction passing through a middle of the fourth driven wheel in the second axis direction is provided to be positioned eccentrically outward in the second axis direction compared to an axial line in the first axis direction passing through a center of the first driving wheel and a center of the second driven wheel.

An axial line in the first axis direction passing through a middle of a driven wheel, which is positioned on one side, among the pair of driven wheels in the second axis direction is provided to be positioned eccentrically outward in the second axis direction compared to an axial line in the first axis direction passing through a center of a driving wheel supported on one side of the first lever member and a center of a driving wheel supported on one side of the second lever member, and an axial line in the first axis direction passing through a middle of a driven wheel, which is positioned on the other side, among the pair of driven wheels in the second axis direction is provided to be positioned eccentrically outward in the second axis direction compared to an axial line in the first axis direction passing through a center of a driving wheel supported on the other side of the first lever member and a center of a driving wheel supported on the other side of the second lever member.

The first driving wheel is driven forward or rearward about the second axis by driving the first driving motor and is steered about a third axis perpendicular to the first axis and the second axis by driving a first steering motor, and the second driving wheel is driven forward or rearward about the second axis by driving the second driving motor and is steered about the third axis by driving a second steering motor.

The pair of driving wheels supported on both ends of the first lever member in the second axis direction are driven forward or rearward about the second axis by driving the driving motors and are steered about a third axis perpendicular to the first axis and the second axis by driving steering motors, and the pair of driving wheels supported on both ends of the second lever member in the second axis direction are driven forward or rearward about the second axis by driving the driving motors and are steered about the third axis perpendicular to the first axis and the second axis by driving steering motors.

### Advantageous Effects

According to a load transport apparatus according to the present invention, even when the ground is uneven, during traveling of the transport apparatus for transporting a load, all driving wheels and driven wheels in contact with the ground can always be maintained by a seesaw action of a first lever member and a second lever member and rotation of a first support frame and a second support frame, and thus, traveling stability can be improved.

Further, the first lever member and the second lever member can relatively rotate about a first axis with respect to a support frame, the first support frame and the second support frame can relatively rotate about a second axis with respect to a loading plate, all wheels can be in contact with the ground even in various situations in which the ground is uneven, smooth rotation can be possible even in rotation traveling, and thus the traveling stability can be improved.

Further, a third driven wheel and a fourth driven wheel positioned on both sides of a middle portion in a first axis direction in a state in which a certain height is maintained are provided, a height of a bottom surface of the load loaded on the load transport apparatus and a height (pass line) of a loading or unloading place can match each other when a load loaded on the load transport apparatus is loaded or unloaded, and thus the load can be smoothly loaded or unloaded.

According to an embodiment, a first driving wheel provided on one side of a rear side of the loading plate and a second driving wheel provided on the other side of a front side of the loading plate can move forward or rearward and can be steered, and thus the forward or rearward movement and the steering of the load transport apparatus can be stably controlled.

According to another embodiment, driving wheels provided on both sides of the first lever member and both sides of the second lever member can move forward or rearward and can be steered, and thus a propulsive force of the load transport apparatus can increase, and the steering can be more stably controlled.

Further, each of a first loading plate rotation support part and a second loading plate rotation support part includes a ball joint, the second loading plate rotation support part can reciprocally move in the first axis direction perpendicular to a pivot shaft in conjunction with the rotation of the first support frame and the second support frame. Thus, when the first support frame and the second support frame rotate relative to each other, interference with the loading plate can be prevented, and thus the first support frame and the second support frame can be smoothly rotated.

Further, the first loading plate rotation support part is provided at a position eccentric toward an axial line of a rotary shaft of the first driving wheel based on a middle portion in the first axis direction between an axial line of the pivot shaft and an axial line of the rotary shaft of the first driving wheel, and the second loading plate rotation support part is provided at a position eccentric toward an axial line of a rotary shaft of the second driving wheel based on a middle portion in the first axis direction between the axial line of the pivot shaft and the rotary shaft of the second driving wheel. Thus, a weight of the load can be evenly distributed to a first transfer support part, a second transfer support part, a third transfer support part, and a fourth transfer support part, so that the load can be stably supported and transported on the loading plate.

Further, a first rotary shaft of the first lever member is provided to be positioned eccentric toward the first driving wheel based on a middle portion between the first driving wheel and a first driven wheel, and a second rotary shaft of the second lever member is provided to be positioned eccentric toward the second driving wheel based on a middle portion between the second driving wheel and a second driven wheel. Thus, by setting a suspension load applied to the first driving wheel and the second driving wheel to be higher than the first driven wheel and the second driven wheel, a frictional force between the first driving wheel and the second driving wheel and the ground can increase, and thus driving propulsive force can increase.

Further, an axial line in the first axis direction connecting a middle portion of the third driven wheel in the second axis direction is positioned eccentric outward in the second axis direction as compared to an axial line in the first axis direction connecting a middle portion of the first driven wheel and the second driving wheel in the second axis direction, and an axial line in the first axis direction connecting a middle portion of the fourth driven wheel in the second axis direction is positioned eccentric outward in the second axis direction as compared to an axial line in the first axis direction connecting a middle portion of the first driving wheel and the second driven wheel in the second axis direction. Thus, even when the load is introduced and loaded through the second axis direction of a long side of the loading plate, the load transport apparatus can be prevented from being tilted and overturned.

### DESCRIPTION OF DRAWINGS

FIG. 1 is a perspective view of a load transport apparatus according to a first embodiment of the present invention from above.

FIG. 2 is a plan view of the load transport apparatus according to the first embodiment of the present invention.

FIG. 3 is a perspective view of the load transport apparatus according to the first embodiment of the present invention from below.

FIG. 4 is a front view of the load transport apparatus according to the first embodiment of the present invention.

FIG. 5 is a left side view of the load transport apparatus according to the first embodiment of the present invention.

FIG. 6A is a perspective view of a first loading plate rotation support part.

FIG. 6B is a front view of the first loading plate rotation support part.

FIG. 7A is a perspective view of a second loading plate rotation support part.

FIG. 7B is a left side view of the second loading plate rotation support part.

FIG. 8 is a left side view illustrating a state in which a first support frame and a second support frame provided in the load transport apparatus according to the first embodiment of the present invention are rotated about a pivot shaft to one side, and thus a second spherical portion of the second loading plate rotation support part slides to one side along a second support shaft.

FIG. 9 is a front view for describing a driving structure for forward or rearward movement and steering of a first driving wheel provided in the load transport apparatus according to the first embodiment of the present invention.

FIG. 10 is a left side view for describing a driving structure for forward or rearward movement and steering of a first driving wheel provided in the load transport apparatus according to the first embodiment of the present invention.

FIG. 11 is a bottom view for describing an eccentric structure of the center of gravity for improving traveling stability of the load transport apparatus according to the first embodiment of the present invention.

FIG. 12 is bottom view of a load transport apparatus according to a second embodiment of the present invention.

** Description of Reference Numerals **

| | |
|---|---|
| 1, 1-1: Load transport apparatus | 100: Loading plate |
| 200: Support frame | 210: First support frame |

211, 212, 213, 214: Opposite front end portions of first support frame

| | |
|---|---|
| 220: Second support frame | 221, 222: Opposite rear end portions of second |
| | support frame |
| 230: Pivot shaft | 300: Loading plate rotation support part |

310, 310-1, 310-2: First loading plate rotation support part

| | |
|---|---|
| 311: First bracket | 311a: Left surface portion of first bracket |
| 311b: Upper surface portion of first bracket | 311c: Right surface portion of first |
| | bracket |
| 311d: Inner space of first bracket | 312: First spherical portion |
| 313: First support shaft | 314: First holder |
| 315: First fixed shaft | 320, 320-1, 320-2: Second loading plate |
| | rotation support part |
| 321: Second bracket | 321a: Rear surface portion of second bracket |
| 321b: Upper surface of second bracket | 321c: Front surface portion of second bracket |
| 321d: Inner space of second bracket | 322: Second spherical portion |
| 323: Second support shaft | 324: Second holder |
| 325: Second fixed shaft | 400: First transfer support part |
| 400A: First traveling driving part | 410: First driving wheel |
| 420: First driven wheel | 421: First driven wheel rotary shaft |

422: First driven wheel rotary shaft support member

| | |
|---|---|
| 423: First rotation support portion | 424: First fixing member |
| 430: First lever member | 440: First rotary shaft |
| 450: First rotary shaft support member | 460: First driving motor |
| 470: First brake | 480: First steering motor |
| 490: First support member | 491: First fixing gear |
| 492: First support plate | 493: First fixing plate |
| 500: Second transfer support part | 500A: Second traveling driving part |
| 510: Second driving wheel | 520: Second driven wheel |
| 530: Second lever member | 540: Second rotary shaft |
| 550: Second rotary shaft support member | 560: Second driving motor |
| 570: Second brake | 580: Second steering motor |
| 590: Second support member | 591: Second fixing gear |
| 592: Second support plate | 593: Second fixing plate |
| 600: Third transfer support part | 610: Third driven wheel |
| 620: Third driven wheel rotary shaft | 630: Third driven wheel rotary shaft support |
| | member |
| 640: Third rotation support part | 650: Third fixing member 650 |
| 700: Fourth transfer support part | 710: Fourth driven wheel |
| 720: Fourth driven wheel rotary shaft | 730: Fourth driven wheel rotary shaft support |
| | member |
| 740: Fourth rotation support part | 750: Fourth fixing member |
| 420-1: Third driving wheel | 460-1: Third driving motor |
| 480-1: Third steering motor | 520-1: Fourth driving wheel |
| 560-1: Fourth driving motor | 580-1: Fourth steering motor |

### MODES OF THE INVENTION

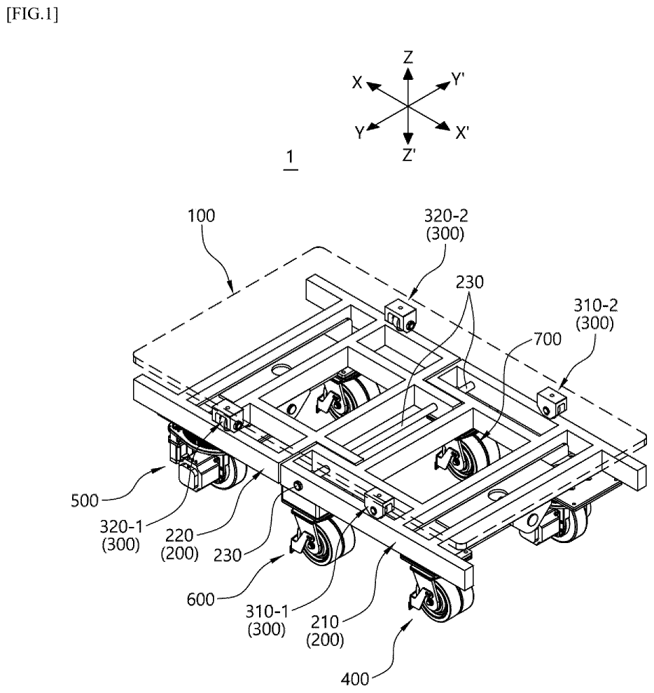

Hereinafter, configurations and operations of exemplary embodiments of the present invention will be described in detail with reference to the accompanying drawings. Hereinafter, in referring to directions herein, direction X-X′ illustrated in FIG. 1 is referred to as a front-rear direction, direction Y-Y′ is referred to as a left-right direction, and direction Z-Z′ is referred to as an up-down direction. Direction X is referred to as a front direction, direction X′ is referred to as a rear direction, direction Y is referred to as a left direction, and direction Y′ is referred to as a right direction. Further, axis X-X′ is interchangeably used as a first axis, axis Y-Y′ is interchangeably used as a second axis, and axis Z-Z′ is interchangeably used as a third axis.

Referring to FIGS. 1 to 5, a load transport apparatus 1 according to a first embodiment of the present invention includes a loading plate 100 on which an object to be loaded is seated, a support frame 200 that supports the loading plate 100, a loading plate rotation support part 300 that supports the loading plate 100 such that the loading plate 100 may rotate relative to the support frame 200, and a first transfer support part 400, a second transfer support part 500, a third transfer support part 600, and a fourth transfer support part 700 that are provided under a rear end, a front end, and both sides of a middle portion of the support frame 200 in a first axis direction to transfer the support frame 200 while the support frame 200 is supported on the ground (not illustrated).

A load to be transported may be directly seated on an upper surface of the loading plate 100 or other control devices or driving devices may be seated thereon together.

The support frame 200 includes a first support frame 210 and a second support frame 220 that share a pivot shaft 230 disposed in a second axis direction, are provided on both sides of the pivot shaft 230 and rotate about the pivot shaft 230 in a vertical direction.

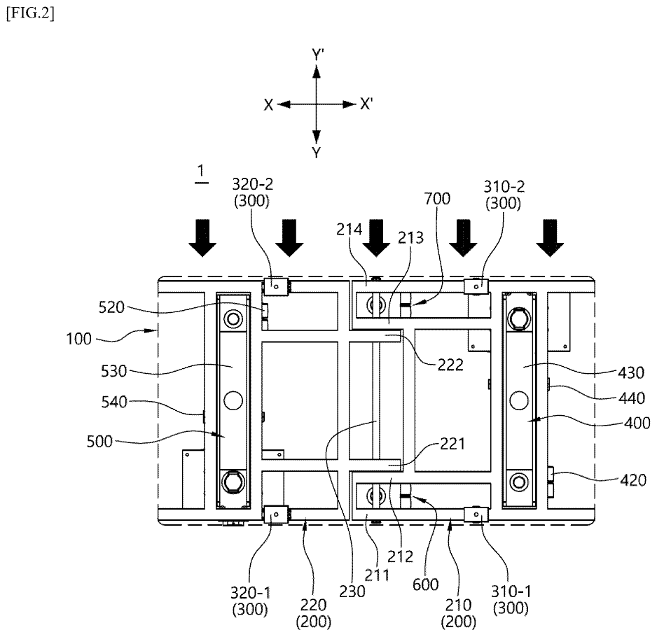

Referring to FIG. 2, opposite front end portions 211, 212, 213, and 214 of the first support frame 210 and opposite rear end portions 221 and 222 of the second support frame 220 are provided to overlap each other in the second axis direction, and the pivot shaft 230 is coupled through the opposite front end portions 211, 212, 213, and 214 of the first support frame 210 and the opposite rear end portions 221 and 222 of the second support frame 220 in the second axis direction. Thus, the first support frame 210 and the second support frame 220 are provided to be rotatable about the pivot shaft 230 in the vertical direction.

A first driving wheel 410 and a first driven wheel 420 provided in the first transfer support part 400 are provided below the first support frame 210 at a position spaced apart rearward from the pivot shaft 230, a second driving wheel 510 and a second driven wheel 520 provided in the second transfer support part 500 are provided below the second support frame 220 at a position spaced apart forward from the pivot shaft 230, and a third driven wheel 610 provided in the third transfer support part 600 and a fourth driven wheel 710 provided in the fourth transfer support part 700 are provided directly under both ends of the pivot shaft 230 in the second axis direction.

When the load transport apparatus 1 travels, when the ground is not flat and has curves or steps, for example, when the ground is not flat in the first axis direction, the first support frame 210 and the second support frame 220 rotate about pivot shaft 230 to one side in correspondence to a ground state. Thus, even when the ground is not flat in the first axis direction, the first driving wheel 410 and the first driven wheel 420 of the first transfer support part 400, the second driving wheel 510 and the second driven wheel 520 of the second transfer support part 500, the third driven wheel 610 of the third transfer support part 600, and the fourth driven wheel 710 of the fourth transfer support part 700 may always be in contact with the ground by relative rotation of the first support frame 210 and the second support frame 220.

The loading plate rotation support part 300 is provided between a bottom surface of the loading plate 100 and an upper surface of the support frame 200 and functions to support the loading plate 100 such that the loading plate 100 may rotate relative to the support frame 200.

The loading plate rotation support part 300 may include a first loading plate rotation support part 310 (310-1 and 310-2) provided between a bottom surface of a rear portion of the loading plate 100 and an upper surface of the first support frame 210 and a second loading plate rotation support part 320 (320-1 and 320-2) provided between a bottom surface of a front portion of the loading plate 100 and an upper surface of the second support frame 220.

The first loading plate rotation support part 310 (310-1 and 310-2) and the second loading plate rotation support part 320 (320-1 and 320-2) have ball-joint structures that allow relative rotation in a plurality of directions and may be provided in pairs at positions spaced apart from each other in the second axis direction. The first loading plate rotation support part 310 (310-1 and 310-2) and the second loading plate rotation support part 320 (320-1 and 320-2) may be provided such that positions thereof are exchanged.

Referring to FIG. 6, the first loading plate rotation support part 310 includes a first bracket 311 including a left surface portion 311a, an upper surface portion 311b, and a right surface portion 311c, having a structure that is open in the front-rear direction and a down direction, and coupled to the bottom surface of the loading plate 100, a first spherical portion 312 provided in an inner space 311d of the first bracket 311, a first support shaft 313 passing through the left surface portion 311a, the first spherical portion 312, and the right surface portion 311c and disposed in the second axis direction, a first holder 314 that surrounds a portion of an outer surface of the first spherical portion 312 and rotates relative to the first spherical portion 312, and a first fixed shaft 315 extending downward from a bottom surface of the first holder 314 and coupled to the upper surface of the first support frame 210.

As the first loading plate rotation support part 310 has the ball-joint structure, when the first support frame 210 and the second support frame 220 relatively rotate about the pivot shaft 230, the first support frame 210 and the loading plate 100 rotate relative to each other via the first loading plate rotation support part 310 in conjunction with the rotation of the first support frame 210.

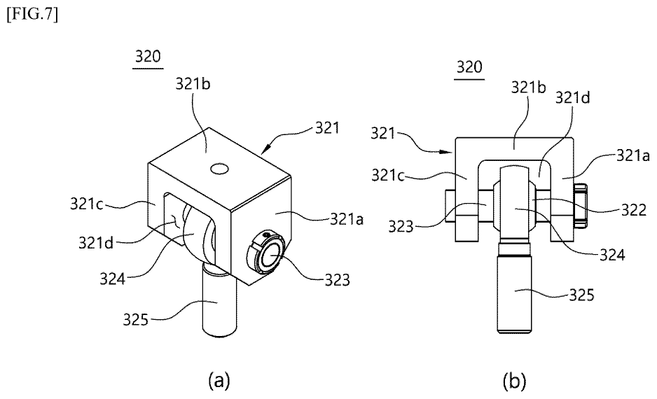

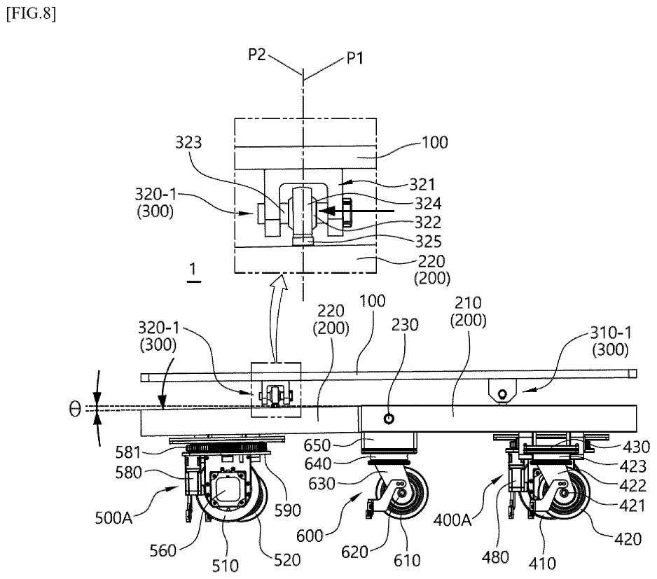

Referring to FIG. 7, the second loading plate rotation support part 320 includes a second bracket 321 including a rear surface portion 321a, an upper surface portion 321b, and a front surface portion 321c, having a structure that is open in the left-right direction and the down direction, and coupled to the bottom surface of the loading plate 100, a second spherical portion 322 provided in an inner space 321d of the second bracket 321, a second support shaft 323 passing through the rear surface portion 321a, the second spherical portion 322, and the front surface portion 321c and disposed in the first axis direction, a second holder 324 that surrounds a portion of an outer surface of the second spherical portion 322 and rotates relative to the second spherical portion 322, and a second fixed shaft 325 extending downward from a bottom surface of the second holder 324 and coupled to the upper surface of the second support frame 220.

A length of the second support shaft 323 positioned in the inner space 321d of the second bracket 321 in the first axis direction is greater than a length of the second spherical portion 322 in the first axis direction, and thus the second spherical portion 322 is provided to reciprocally slide along the second support shaft 323 in the first axis direction.

As the second loading plate rotation support part 320 has the ball-joint structure and the reciprocally slidable structure, when the first support frame 210 and the second support frame 220 relatively rotate about the pivot shaft 230 as illustrated in FIG. 8, for example, when the first support frame 210 rotates a predetermined angle θ with respect to a horizontal plane, the second spherical portion 322 and the second holder 324 and the second fixed shaft 325 coupled thereto slide from a middle point P1 of the second support shaft 323 in the first axis direction to a point P2 spaced apart from one side in the first axis direction in conjunction with the rotation, and at the same time, the second support frame 220 and the loading plate 100 rotate relative to each other via the second loading plate rotation support part 320 in conjunction with the rotation of the second support frame 220.

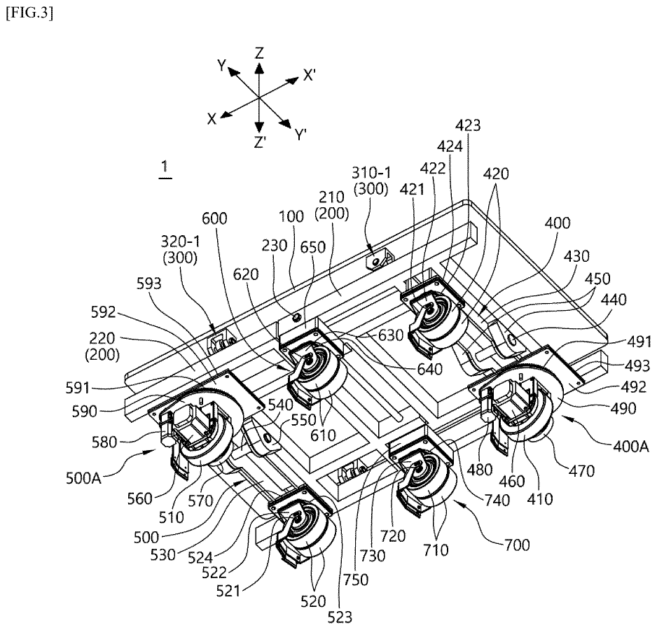

Hereinafter, configurations of the first transfer support part 400, the second transfer support part 500, the third transfer support part 600, and the fourth transfer support part 700 will be described with reference to FIGS. 3 to 5.

The first transfer support part 400 is provided at a lower portion of a rear side of the support frame 200 and includes the first driving wheel 410 rotationally driven by a first driving motor 460 and provided on a right side in the second axis direction, the first driven wheel 420 provided on a left side in the second axis direction, a first lever member 430 that supports the first driving wheel 410 and the first driven wheel 420 at opposite ends in the second axis direction and has a predetermined length in the second axis direction, a first rotary shaft 440 passing through and supporting a middle portion of the first lever member 430 in a longitudinal direction in the first axis direction, and a first rotary shaft support member 450 that supports the first rotary shaft 440 and is coupled to a bottom surface of the first support frame 210.

A single bogie structure is provided in the lower portion of the rear side of the support frame 200 by the first transfer support part 400.

The first lever member 430 is coupled to relatively rotate about the first rotary shaft 440 with respect to the first support frame 210.

The first transfer support part 400 includes a first traveling driving part 400A for forward or rearward driving and steering of the first driving wheel 410. The first traveling driving part 400A includes a first driving motor 460 that provides power for the forward or rearward driving of the first driving wheel 410, a first brake 470 that brakes the first driving wheel 410 when power supply is cut off, and a first steering motor 480 that provides power for the steering of the first driving wheel 410.

The first driving wheel 410 is driven to move forward or rearward by rotating in the second axis direction passing through a center of the first driving wheel 410 by the driving of the first driving motor 460 and is steered by rotating in both directions in a third axis direction passing through the center of the first driving wheel 410 in the vertical direction by the driving of the first steering motor 480.

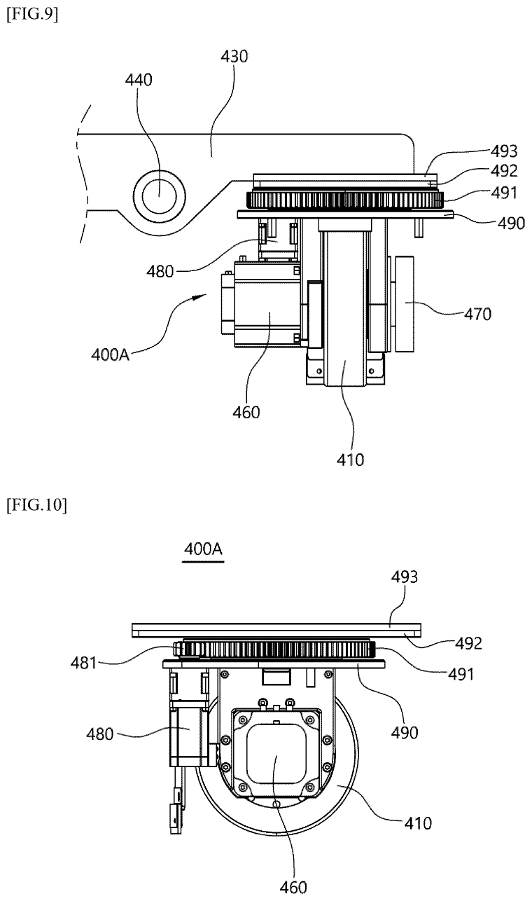

Referring to FIGS. 9 and 10 together, a first fixing plate 493 coupled to the first lever member 430 and a first support plate 492 thereunder are coupled to a bottom surface of one side of a rear side of the first support frame 210, in which the first driving wheel 410 is positioned, in a stacked structure, and a first fixing gear 491 is coupled to a bottom surface of the first support plate 492. A first support member 490 that may support the first driving motor 460 and the first driving wheel 410 and rotate about the third axis relative to the first fixing gear 491 is coupled to a lower portion of the first fixing gear 491. A first pinion gear 481 is engaged with a shaft of the first steering motor 480, and the first pinion gear 481 is gear-engaged with the first fixing gear 491.

The first brake 470 for braking the first driving wheel 410 when power supply is cut off is provided on the other side of the first driving wheel 410.

The first fixing gear 491 is coupled to the bottom surface of the first support frame 210 in a fixed state so as not to rotate, a rotary shaft (not illustrated) of the first support member 490 is connected to the first fixing gear 491 to be relatively rotatable, and the first steering motor 480 is coupled to the first support member 490. Thus, when the first pinion gear 481 rotates by driving the first steering motor 480, the first pinion gear 481 moves along a circumference of the gear-engaged first fixing gear 491, and all the first steering motor 480, the first support member 490, the first driving motor 460, and the first brake 470 rotate together in conjunction with the movement. Thus, a steering operation of the first driving wheel 410 is performed according to a rotational direction and a rotational amount of the first steering motor 480.

The first driven wheel 420 is coupled to a first driven wheel rotary shaft 421 disposed in the second axis direction. Opposite ends of the first driven wheel rotary shaft 421 are supported by a first driven wheel rotary shaft support member 422, a first rotation support portion 423 that may rotate about the third axis is coupled to an upper portion of the first driven wheel rotary shaft support member 422, the first rotation support portion 423 is rotatably coupled to a first fixing member 424, and the first fixing member 424 is coupled to a left portion of the first lever member 430 in the first axis direction.

The second transfer support part 500 is provided at a lower portion of a front side of the support frame 200 and includes the second driving wheel 510 rotationally driven by a second driving motor 560 and provided on the left side in the second axis direction, the second driven wheel 520 provided on the right side in the second axis direction, a second lever member 530 that supports the second driving wheel 510 and the second driven wheel 520 at opposite ends in the second axis direction and has a predetermined length in the second axis direction, a second rotary shaft 540 passing through and supporting a middle portion of the second lever member 530 in a longitudinal direction in the first axis direction, and a second rotary shaft support member 550 that supports the second rotary shaft 540 and is coupled to a bottom surface of the second support frame 220.

Another bogie structure is provided in the lower portion of the front side of the support frame 200 by the second transfer support part 500.

The second lever member 530 is coupled to relatively rotate about the second rotary shaft 540 with respect to the second support frame 220.

The second transfer support part 500 includes a second traveling driving part 500A for forward or rearward driving and steering of the second driving wheel 510. The second traveling driving part 500A includes a second driving motor 560 that provides power for the forward or rearward driving of the second driving wheel 510, a second brake 570 that brakes the second driving wheel 510 when power supply is cut off, and a second steering motor 580 that provides power for the steering of the second driving wheel 510.

The second driving wheel 510 is driven to move forward or rearward by rotating in the second axis direction passing through a center of the second driving wheel 510 by the driving of the second driving motor 560 and is steered by rotating in both directions in the third axis direction passing through the center of the second driving wheel 510 in the vertical direction by the driving of the second steering motor 580.

A second fixing plate 593 coupled to the second lever member 530 and a second support plate 592 thereunder are coupled to a bottom surface of an opposite side to a front side of the second support frame 220, in which the second driving wheel 410 is positioned, in a stacked structure, and a second fixing gear 591 is coupled to a bottom surface of the second support plate 592. A second support member 590 that may support the second driving motor 560 and the second driving wheel 510 and rotate about the third axis relative to the second fixing gear 591 is coupled to a lower portion of the second fixing gear 591. A second pinion gear 581 is engaged with a shaft of the second steering motor 580, and the second pinion gear 581 is gear-engaged with the second fixing gear 591.

The second brake 570 for braking the second driving wheel 510 when power supply is cut off is provided on the other side of the second driving wheel 510.

The second fixing gear 591 is coupled to the bottom surface of the second support frame 220 in a fixed state so as not to rotate, a rotary shaft (not illustrated) of the second support member 590 is connected to the second fixing gear 591 to be relatively rotatable, and the second steering motor 580 is coupled to the second support member 590. Thus, when the second pinion gear 581 rotates by driving the second steering motor 580, the second pinion gear 581 moves along a circumference of the gear-engaged second fixing gear 591, and all the second steering motor 580, the second support member 590, the second driving motor 560, and the second brake 570 rotate together in conjunction with the movement. Thus, a steering operation of the second driving wheel 510 is performed according to a rotational direction and a rotational amount of the second steering motor 580.

The second driven wheel 520 is coupled to a second driven wheel rotary shaft 521 disposed in the second axis direction. Opposite ends of the second driven wheel rotary shaft 521 are supported by a second driven wheel rotary shaft support member 522, a second rotation support portion 523 that may rotate about the third axis is coupled to an upper portion of the second driven wheel rotary shaft support member 522, the second rotation support portion 523 is rotatably coupled to a second fixing member 524, and the second fixing member 524 is coupled to a right portion of the second lever member 530 in the first axis direction.

As described above, the first transfer support part 400 and the second transfer support part 500 are provided in a structure in which the first transfer support part 400 and the second transfer support part 500 are symmetrical to each other in the left-right direction at the lower portion of the rear side and the lower portion of the front side of the support frame 200.

When the load transport apparatus 1 travels, when the ground is not flat and has curves or steps, for example, when the ground is not flat in the second axis direction, the first lever member 430 of the first transfer support part 400 rotates about the first rotary shaft 440 to one side in correspondence top the ground state, and the second lever member 530 of the second transfer support part 500 rotates about the second rotary shaft 540 to one side in correspondence to the ground state.

Thus, even when the ground is not flat in the second axis direction, the first driving wheel 410 and the first driven wheel 420 of the first transfer support part 400, the second driving wheel 510 and the second driven wheel 520 of the second transfer support part 500, the third driven wheel 610 of the third transfer support part 600, and the fourth driven wheel 710 of the fourth transfer support part 700 may always be in contact with the ground by rotation of the first lever member 430 and the second lever member 530 due to a seesaw action.

The third transfer support part 600 includes the third driven wheel 610 provided at a left lower portion in the second axis direction in the middle portion of the support frame 200 in the first axis direction. The third driven wheel 610 is coupled to a third driven wheel rotary shaft 620 disposed in the second axis direction. Opposite ends of the third driven wheel rotary shaft 620 are supported by a third driven wheel rotary shaft support member 630, and a third rotation support part 640 that may rotate about the third axis is coupled to an upper portion of the third driven wheel rotary shaft support member 630. The third rotation support part 640 is rotatably coupled to a third fixing member 650, and the third fixing member 650 is coupled to a left bottom surface of the support frame 200 positioned below the pivot shaft 230.

The fourth transfer support part 700 includes the fourth driven wheel 710 provided at a right lower portion in the second axis direction in the middle portion of the support frame 200 in the first axis direction. The fourth driven wheel 710 is coupled to a fourth driven wheel rotary shaft 720 disposed in the second axis direction. Opposite ends of the fourth driven wheel rotary shaft 720 are supported by a fourth driven wheel rotary shaft support member 730, and a fourth rotation support part 740 that may rotate about the third axis is coupled to an upper portion of the fourth driven wheel rotary shaft support member 730. The fourth rotation support part 740 is rotatably coupled to a fourth fixing member 750, and the fourth fixing member 750 is coupled to a right bottom surface of the support frame 200 positioned below the pivot shaft 230.

As described above, the third transfer support part 600 and the fourth transfer support part 700 are provided in a structure in which the third transfer support part 600 and the fourth transfer support part 700 are symmetrical to each other under both sides of the middle portion of the support frame 200 in the first axis direction.

Unlike the bogie structure of the first transfer support part 400 and the second transfer support part 500, the third driven wheel 610 of the third transfer support part 600 and the fourth driven wheel 710 of the fourth transfer support part 700 are provided such that a height thereof in the third axis direction is maintained constant.

Thus, as indicated by arrows in FIG. 2, when the load is moved from a loading or unloading place (not illustrated) to the upper surface of the loading plate 100, or conversely, when the load loaded on the upper surface of the loading plate 100 is moved to the loading or unloading place, the third driven wheel 610 and the fourth driven wheel 710 are provided while a height thereof is maintained constant, a height of a bottom surface of the load loaded on the load transport apparatus 1 and a height (pass line) of the loading or unloading place may match each other, and thus the load may be smoothly loaded or unloaded.

Further, as described above, the first driving wheel 410 and the second driving wheel 510 may be provided at two corner points of the support frame 200 in a diagonal direction, the first driven wheel 420 and the second driven wheel 520 may be provided at two corner points of the support frame 200 in another diagonal direction, and the first driving wheel 410 and the second driving wheel 510 may move forward or rearward and steer. Thus, it is possible to stably control the forward or rearward movement and steering operations of the load transport apparatus 1.

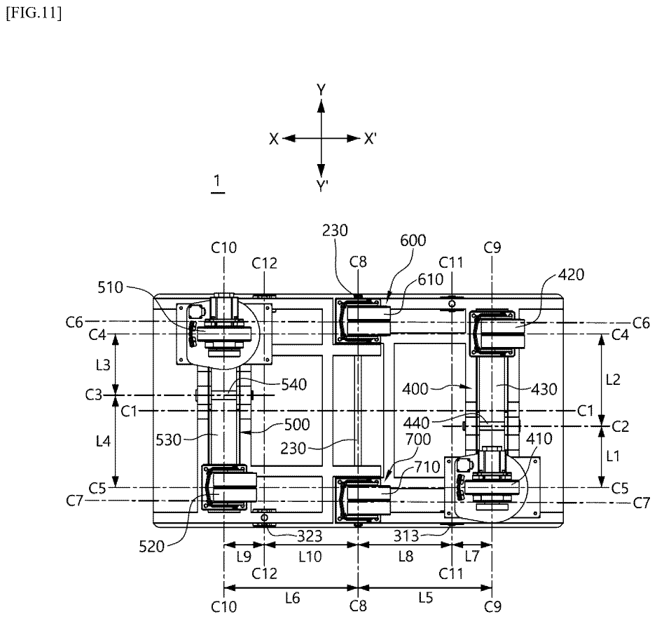

Hereinafter, an eccentric structure of the center of gravity of components for improving traveling stability of the load transport apparatus 1 according to the present invention will be described with reference to FIG. 11.

In FIG. 11, reference numeral C1 denotes a middle line of the load transport apparatus in the second axis direction, reference numeral C2 denotes an axial line of the first rotary shaft 440, reference numeral C3 denotes an axial line of the second rotary shaft 540, reference numeral C4 denotes an axial line passing through a middle of the first driven wheel 420 and the second driving wheel 510 in the second axis direction and parallel to the first axis direction, reference numeral C5 denotes an axial line passing through a middle of the first driving wheel 410 and the second driven wheel 520 in the second axis direction and parallel to the first axis direction, reference numeral C6 denotes an axial line passing through a middle of the third driven wheel 610 in the second axis direction and parallel to the first axis direction, reference numeral C7 denotes an axial line passing through a middle of the fourth driven wheel 710 in the second axis direction and parallel to the first axis direction, reference numeral C8 denotes an axial line of the pivot shaft 230, reference numeral C9 denotes an axial line of a first driving wheel rotary shaft, reference numeral C10 denotes an axial line of a second driving wheel rotary shaft, reference numeral C11 denotes an axial line of the first support shaft 313 of the first loading plate rotation support part 310, and reference numeral C12 denotes an axial line of the second support shaft 323 of the second loading plate rotation support part 320.

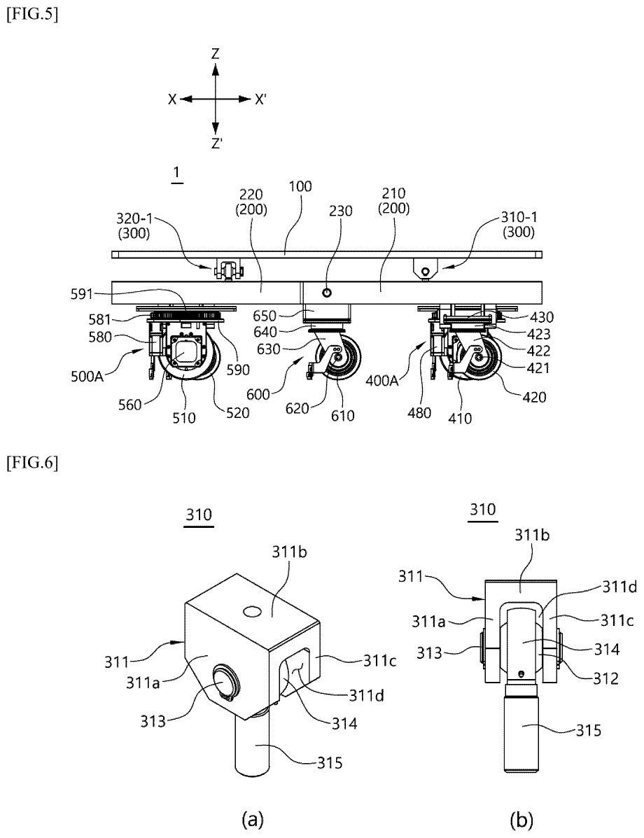

Referring to FIG. 11 and FIG. 5, the axial line C11 of the first support shaft 313 of the first loading plate rotation support part 310-1 or 310-2 is provided at a position eccentric toward the axial line C9 of the rotary shaft of the first driving wheel 410 with respect to a middle between the axial line C8 of the pivot shaft 230 and the axial line C9 of the rotary shaft of the first driving wheel 410 in the first axis direction (L8>L7). As the embodiment, a ratio of the distance L8 between the axial line C11 of the first support shaft 313 and the axial line C8 of the pivot shaft 230 and the distance L7 between the axial line C11 of the first support shaft 313 and the axial line C9 of the rotary shaft of the first driving wheel 410 may be set to a ratio of 7:3.

Further, the axial line C12 of the second support shaft 323 of the second loading plate rotation support part 320-1 or 320-2 is provided at a position eccentric toward the axial line C10 of the rotary shaft of the second driving wheel 510 with respect to a middle between the axial line C8 of the pivot shaft 230 and the axial line C10 of the rotary shaft of the second driving wheel 510 in the first axis direction (L10>L9). As the embodiment, a ratio of the distance L10 between the axial line C12 of the second support shaft 323 and the axial line C8 of the pivot shaft 230 and the distance L9 between the axial line C12 of the second support shaft 323 and the axial line C10 of the rotary shaft of the second driving wheel 510 may be set to a ratio of 7:3.

According to the above configuration, as compared to a case in which the axial line C11 of the first support shaft 3131 is positioned in a middle between the axial line C8 of the pivot shaft 230 and the axial line C9 of the rotary shaft of the first driving wheel 410 in the first axis direction (L8=L7) and the axial line C12 of the second support shaft 323 is positioned in a middle between the axial line C8 of the pivot shaft 230 and the axial line C10 of the rotary shaft of the second driving wheel 510 (L10=L9), a weight of the load may not be concentrated on the third driven wheel 610 and the fourth driven wheel 701 and may be evenly distributed to the first transfer support part 400, the second transfer support part 500, the third transfer support part 600, and the fourth transfer support part 700, and thus the load loaded on the loading plate 100 may be stably supported and transported.

In FIG. 11, reference numeral L5, which is not described, indicates a distance between the axial line C8 of the pivot shaft 230 and the axial line C9 of the rotary shaft of the first driving wheel 410, and reference numeral L6 indicates a distance between the axial line C8 of the pivot shaft 230 and the axial line C10 of the rotary shaft of the second driving wheel 510. L5 and L6 may be set to the same distance.

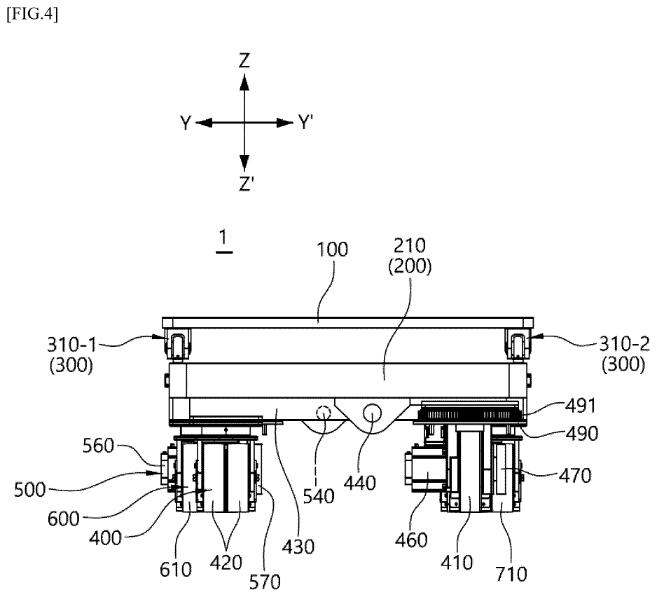

Referring to FIGS. 11 and 4, the axial line C2 of the first rotary shaft 440 is provided at a position eccentric toward the first driving wheel 410 with respect to the middle C1 in the second axis direction between the axial line C5 passing through the middle of the first driving wheel 410 in the second axis direction and parallel to the first axis direction and the axial line C4 passing through the middle of the first driven wheel 420 in the second axis direction and parallel to the first axis direction (L2>L1). The weight of the load loaded on the loading plate 100 is applied to the first rotary shaft 440 through the first support frame 210 and the first rotary shaft support member 450.

According to the above configuration, the first rotary shaft 440, which serves as the center of gravity of the weight applied through the first support frame 210 and the first rotary shaft support member 450, is positioned closer to the first driving wheel 410 than to the first driven wheel 420. Thus, by setting a suspension load in charge of the first driving wheel 410 to be higher than that of the first driven wheel 420, contact between the first driving wheel 410 and the ground may always be maintained, and a frictional force between the first driving wheel 410 and the ground may increase so as to increase a driving force.

Likewise, the axial line C3 of the second rotary shaft 540 is provided at a position eccentric toward the second driving wheel 510 with respect to the middle C1 in the second axis direction between the axial line C4 passing through the middle of the second driving wheel 510 in the second axis direction and parallel to the first axis direction and the axial line C5 passing through the middle of the second driven wheel 520 in the second axis direction and parallel to the first axis direction (L4>L3). The weight of the load loaded on the loading plate 100 is applied to the second rotary shaft 540 through the second support frame 220 and the second rotary shaft support member 550.

According to the above configuration, the second rotary shaft 540, which serves as the center of gravity of the weight applied through the second support frame 220 and the second rotary shaft support member 550, is positioned closer to the second driving wheel 510 than to the second driven wheel 520. Thus, by setting a suspension load in charge of the second driving wheel 510 to be higher than that of the second driven wheel 520, contact between the second driving wheel 510 and the ground may always be maintained, and a frictional force between the second driving wheel 510 and the ground may increase so as to increase the driving force.

Referring to FIGS. 11 and 2, the axial line C6 in the first axis direction passing through the middle of the third driven wheel 610 in the second axis direction is provided to be eccentrically positioned outward in the second axis direction (upward based on FIG. 11) as compared to the axial line C4 in the first axis direction passing through the center of the first driven wheel 420 and the center of the second driving wheel 510.

In addition, the axial line C7 in the first axis direction passing through the middle of the third driven wheel 710 in the second axis direction is provided to be positioned eccentrically outward in the second axis direction (upward based on FIG. 11) as under the to the axial line C5 in the first axis direction passing through the center of the first driven wheel 410 and the center of the second driven wheel 520.

According to this configuration, when the load is loaded from the Y′ direction to the Y direction as indicated by arrows in FIG. 2, the weight of the load is first applied to the third driven wheel 610 provided at a certain height. In contrast, when the load is loaded from the Y direction to the Y′ direction, the weight of the load is first applied to the fourth driven wheel 710 provided at a certain height. Thus, even when the load is introduced and loaded through a long side of the loading plate 100 in the second axis (Y-Y′) direction, the load transport apparatus 1 may be prevented from being tiled and overturned, the height of the pass line may be maintained constant, and thus the load may be smoothly loaded or unloaded.

Further, in the load transport apparatus 1 according to the present invention, a pair of bogie structures parallel to the axial direction and the first support frame 210 and the second support frame 220 in a direction perpendicular to the axial direction of the pair of bogie structures may relatively rotate about the pivot shaft 230, and thus a link structure suitable for a logistics transport robot having a large weight of the load and a narrow space for installing a driving unit.

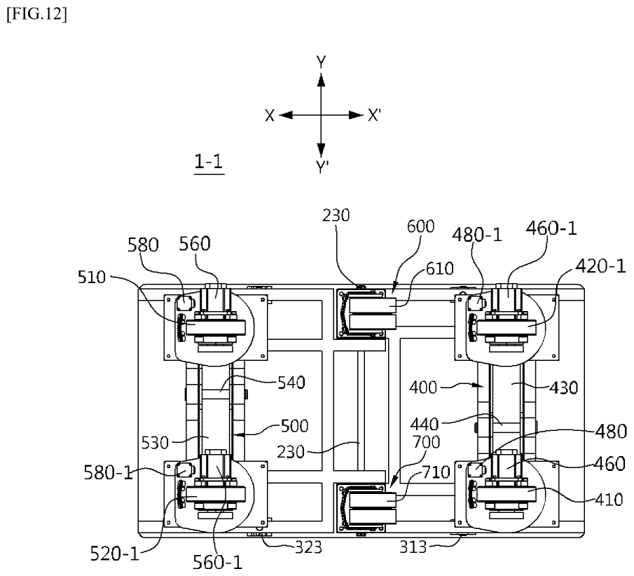

Referring to FIG. 12, a load transport apparatus 1-1 according to a second embodiment of the present invention includes a loading plate 100 on which an object to be loaded is seated, a support frame 200 that supports the loading plate 100, a loading plate rotation support part 300 that supports the loading plate 100 such that the loading plate 100 may rotate relative to the support frame 200, and a first transfer support part 400, a second transfer support part 500, a third transfer support part 600, and a fourth transfer support part 700 that are provided under a rear end, a front end, and both sides of a middle portion of the support frame 200 in a first axis direction to transfer the support frame 200 while the support frame 200 is supported on the ground (not illustrated).

The second embodiment differs from the above-described first embodiment in that the first driven wheel 420 supported on the other side of the first lever member 430 is replaced with a third driving wheel 420-1 and the second driven wheel 520 supported on one side of the second lever member 530 is replaced with a fourth driving wheel 520-1, and the other configurations of the second embodiment are the same as the first embodiment.

That is, the load transport apparatus 1-1 according to the second embodiment of the present invention includes a pair of driving wheels 410 and 420-1 supported on both ends of the first lever member 430 in the second axis direction, a pair of driving motors 460 and 460-1 for driving the pair of driving wheels 410 and 420-1 supported on both ends of the first lever member 430 in the second axis direction, a pair of driving wheels 510 and 520-1 supported on both ends of the second lever member 530 in the second axis direction, a pair of driving motors 560 and 560-1 for driving the pair of driving wheels 510 and 520-1 supported on both ends of the second lever member 530 in the second axis direction, and a pair of driven wheels 610 and 710 connected to both lower portions of a middle portion of the support frame 200 in the first axis direction.

The pair of driving wheels 410 and 420-1 supported on both ends of the first lever member 430 in the second axis direction are driven forward or rearward about the second axis by driving each of the driving motors 460 and 460-1 and steered about the third axis perpendicular to the first axis and the second axis by driving each of the steering motors 480 and 480-1.

The pair of driving wheels 510 and 520-1 supported on both ends of the second lever member 530 in the second axis direction are driven forward or rearward about the second axis by driving each of the driving motors 560 and 560-1 and steered about the third axis perpendicular to the first axis and the second axis by driving each of the steering motors 580 and 580-1.

Further, when the load is loaded or unloaded, to prevent the load transport apparatus 1-1 from being tilted and overturned and to maintain the height of the pass line constant, the axial line in the first axis direction passing through the middle of the driven wheel 610, which is positioned on one side, among the pair of driven wheels 610 and 710 in the second axis direction is provided to be positioned eccentrically outward in the second axis direction as compared to the axial line in the first axis direction passing through the center of the driving wheel 420-1 supported on one side of the first lever member 430 and the center of the driving wheel 510 supported on one side of the second lever member 530, and the axial line in the first axis direction passing through the middle of the driven wheel 710, which is positioned on the other side, among the pair of driven wheels 610 and 710 in the second axis direction is provided to be positioned eccentrically outward in the second axis direction as compared to the axial line in the first axis direction passing through the center of the driving wheel 510 supported on the other side of the first lever member 430 and the center of the driving wheel 520-1 supported on the second lever member 530.

As described above, in the second embodiment, the respective driving wheels 410, 420-1, 510, and 520-1 are provided in both sides of the first lever member 430 and both sides of the second lever member 530, and each of the driving wheels 410, 420-1, 510, and 520-1 may be driven forward or rearward or steered. Thus, a propulsive force of the load transport apparatus 1-1 may be further improved, and a steering operation may be more stably controlled.

As described above, exemplary embodiments of the present invention have been described in detail. However, the present invention is not limited to the above-described embodiments, and various modifications may be implemented without departing from the appended claims, the detailed description of the invention, and the accompanying drawings, and also belong to the present invention.

1. A load transport apparatus comprising:
a loading plate on which an object to be loaded is seated;
a support frame which supports the loading plate;
a first lever member connected to a lower portion of a rear end portion of the support frame, coupled to the support frame to be relatively rotatable about a first rotary shaft disposed in a first axis direction with respect to the support frame, and having a predetermined length in a second axis direction perpendicular to the first axis direction;
a first driving wheel and a first driven wheel supported on both ends of the first lever member in the second axis direction and driven by a first driving motor;
a second lever member connected to a lower portion of a front end portion of the support frame, coupled to the support frame to be relatively rotatable about a second rotary shaft disposed in the first axis direction with respect to the support frame, and having a predetermined length in the second axis direction;
a second driving wheel and a second driven wheel supported on both ends of the second lever member in the second axis direction and driven by a second driving motor;
a third driven wheel connected to a lower portion of one side of a middle portion of the support frame in the first axis direction; and
a fourth driven wheel connected to a lower portion of the other side of the middle portion of the support frame in the first axis direction.

2. A load transport apparatus comprising:
a loading plate on which an object to be loaded is seated;
a support frame which supports the loading plate;
a first lever member connected to a lower portion of a rear end portion of the support frame, coupled to the support frame to be relatively rotatable about a first rotary shaft disposed in a first axis direction with respect to the support frame, and having a predetermined length in a second axis direction perpendicular to the first axis direction;
a pair of driving wheels supported on both ends of the first lever member in the second axis direction;
a pair of driving motors for driving the pair of driving wheels supported on both ends of the first lever member in the second axis direction;
a second lever member connected to a lower portion of a front end portion of the support frame, coupled to the support frame to be relatively rotatable about a second rotary shaft disposed in the first axis direction with respect to the support frame, and having a predetermined length in the second axis direction;
a pair of driving wheels supported on both ends of the second lever member in the second axis direction;
a pair of driving motors for driving the pair of driving wheels supported on both ends of the second lever member in the second axis direction; and
a pair of driven wheels connected to both lower portions of a middle portion of the support frame in the first axis direction.

3. The load transport apparatus of claim 1, wherein the first driving wheel and the second driving wheel are provided at two corner points of the support frame in a diagonal direction,
the first driven wheel and the second driven wheel are provided at two corner points of the support frame in another diagonal direction, and
the third driven wheel and the fourth driven wheel are each provided at a middle portion of a corresponding long side of the support frame.

4. The load transport apparatus of claim 1 or 2, wherein the support frame includes a first support frame and a second support frame which share a pivot shaft disposed in the second axis direction, are provided on both sides of the pivot shaft, and are rotatable about the pivot shaft in an up-down direction.

5. The load transport apparatus of claim 4, wherein the first driving wheel and the first driven wheel are provided under the first support frame at a position spaced apart rearward from the pivot shaft,
the second driving wheel and the second driven wheel are provided at a lower portion of the second support frame at a position spaced apart forward from the pivot shaft, and
the third driven wheel and the fourth driven wheel are provided directly under both ends of the pivot shaft in the second axis direction.

6. The load transport apparatus of claim 4, wherein a loading plate rotation support part which supports the loading plate such that the loading plate is rotatable relative to the support frame is provided between a bottom surface of the loading plate and an upper surface of the support frame, and
the loading plate rotation support part includes a pair of first loading plate rotation support parts positioned between a bottom surface of a rear portion of the loading plate and an upper surface of the first support frame and provided on both sides in the second axis direction, and a pair of second loading plate rotation support parts positioned between a bottom surface of a front portion of the loading plate and an upper surface of the second support frame and provided on both sides in the second axis direction.

7. The load transport apparatus of claim 6, wherein the first loading plate rotation support part and the second loading plate rotation support part include a ball joint that allows relative rotation between the loading plate and the first support frame and the second support frame, and
one of the first loading plate rotation support part and the second loading plate rotation support part is provided to reciprocally slide in the first axis direction perpendicular to the pivot shaft in conjunction with the rotation of the first support frame and the second support frame that relatively rotate about the pivot shaft.

8. The load transport apparatus of claim 6, wherein the first loading plate rotation support part is provided at a position eccentric toward an axial line of a rotary shaft of the first driving wheel based on a middle between an axial line of the pivot shaft and the axial line of the rotary shaft of the first driving wheel in the first axis direction, and
the second loading plate rotation support part is provided at a position eccentric toward an axial line of a rotary shaft of the second driving wheel based on a middle between the axial line of the pivot shaft and the axial line of the rotary shaft of the second driving wheel in the first axis direction.

9. The load transport apparatus of claim 1, wherein the first rotary shaft is provided at a position eccentric toward the first driving wheel based on a middle in the second axis direction between an axial line in the first axis direction passing through a middle of the first driving wheel in the second axis direction and an axial line in the first axis direction passing through a middle of the first driven wheel in the second axis direction.

10. The load transport apparatus of claim 1, wherein the second rotary shaft is provided at a position eccentric toward the second driving wheel based on a middle in the second axis direction between an axial line in the first axis direction passing through a middle of the second driving wheel in the second axis direction and an axial line in the first axis direction passing through a middle of the second driven wheel in the second axis direction.

11. The load transport apparatus of claim 1, wherein an axial line in the first axis direction passing through a middle of the third driven wheel in the second axis direction is provided to be positioned eccentrically outward in the second axis direction compared to an axial line in the first axis direction passing through a center of the first driven wheel and a center of the second driving wheel, and
an axial line in the first axis direction passing through a middle of the fourth driven wheel in the second axis direction is provided to be positioned eccentrically outward in the second axis direction compared to an axial line in the first axis direction passing through a center of the first driving wheel and a center of the second driven wheel.

12. The load transport apparatus of claim 2, wherein an axial line in the first axis direction passing through a middle of a driven wheel, which is positioned on one side, among the pair of driven wheels in the second axis direction is provided to be positioned eccentrically outward in the second axis direction compared to an axial line in the first axis direction passing through a center of a driving wheel supported on one side of the first lever member and a center of a driving wheel supported on one side of the second lever member, and
an axial line in the first axis direction passing through a middle of a driven wheel, which is positioned on the other side, among the pair of driven wheels in the second axis direction is provided to be positioned eccentrically outward in the second axis direction compared to an axial line in the first axis direction passing through a center of a driving wheel supported on the other side of the first lever member and a center of a driving wheel supported on the other side of the second lever member.

13. The load transport apparatus of claim 1, wherein the first driving wheel is driven forward or rearward about the second axis by driving the first driving motor and is steered about a third axis perpendicular to the first axis and the second axis by driving a first steering motor, and
the second driving wheel is driven forward or rearward about the second axis by driving the second driving motor and is steered about the third axis by driving a second steering motor.

14. The load transport apparatus of claim 2, wherein the pair of driving wheels supported on both ends of the first lever member in the second axis direction are driven forward or rearward about the second axis by driving the driving motors and are steered about a third axis perpendicular to the first axis and the second axis by driving steering motors, and
the pair of driving wheels supported on both ends of the second lever member in the second axis direction are driven forward or rearward about the second axis by driving the driving motors and are steered about the third axis perpendicular to the first axis and the second axis by driving steering motors.
